(19) United States
(12) Patent Application Publication
(10) Pub. No.: US 2022/0088566 A1
(43) Pub. Date: Mar. 24, 2022

(54) GRAPHENE WOOL AND MANUFACTURE THEREOF

(71) Applicant: UNIVERSITY OF PRETORIA, Pretoria (ZA)

(72) Inventors: Patricia Forbes, Irene (ZA); Genna-Leigh Schoonraad, Hartbeespoort (ZA)

(73) Assignee: UNIVERSITY OF PRETORIA, Pretoria (ZA)

(21) Appl. No.: 17/310,360

(22) PCT Filed: Feb. 1, 2019
(86) PCT No.: PCT/ZA2020/050005

§ 371 Date: Jul. 29, 2021

(30) Foreign Application Priority Data
Feb. 1, 2019 (ZA) 2019/00674
Feb. 1, 2019 (ZA) 2019/00675

(51) Int. Cl. B01J 20/20; B01J 19/00; B01J 19/14; C01B 32/186; B01J 20/28

(52) U.S. Cl. CPC B01J 20/20; B01J 19/0013; B01J 19/14; C01B 32/186; B01J 20/28011; C01P 2004/02; B01J 20/28023; B01J 20/28002; C01P 2002/82; B01J 2219/00164; B01J 2220/66; B01J 19/0006

(57) ABSTRACT

The invention provides a system for manufacturing graphene wool which includes a receptacle, a graphene growth substrate locatable inside the receptacle, a heating device for increasing the temperature inside the receptacle, an inlet gas flow communication with the receptacle for controlling the introduction of gaseous substances into the receptacle, and a cooling device for rapidly decreasing the temperature inside the receptacle. The invention extends to a method for manufacturing graphene wool and to an air pollutant trap which includes: a sorbent, and a housing for housing the sorbent, wherein the sorbent includes graphene.

### TECHNICLA FIELD

The invention relates to graphene wool and the manufacture thereof, as well as use thereof in various applications such as air pollutant sampling and an air pollutant trap, amongst other uses.

### BACKGROUND TO THE INVENTION

Graphene is a form of carbon defined by a single layer of carbon atoms arranged in a hexagonal lattice. Graphene is further classified as a semi-metal and is the building block of other well-known forms of carbon such as graphite and diamond.

Graphene is sought after due to its thermal and chemical stability, high specific surface area and hydrophobic properties.

As a result of its exceptional properties, graphene has gained popularity in many different technologies for a wide range of applications and the applicant developed a unique and relatively low cost procedure and system for synthesising graphene wool as disclosed hereunder.

Further, monitoring of air pollutant concentrations and air quality is critical, particularly where monitoring of air pollutants is required by law. Typical air pollutants include volatile organic compounds (VOCs) and semi volatile organic compounds (SVOCs), respectively. These pollutants are typically emitted by the petrochemical, agricultural, paint and mining industries.

Current commercially available carbon based sorbents which include activated charcoal, Anasorb 747™, Carboxens™ and carbon molecular sieves, are commonly used to sample VOCs and SVOCs in air.

One downside associated with these sorbents is that they typically require solvent extraction prior to analysis, which is costly and further, environmentally unfriendly.

Moreover, these kinds of sorbents generally cannot be re-used which increases operational costs.

The applicant having considered the above proposes the invention described hereunder.

### SUMMARY OF THE INVENTION

According to a first aspect of the invention, there is provided a system for manufacturing graphene wool which includes:
a receptacle;
a graphene growth substrate locatable inside the receptacle;
a heating device for increasing the temperature inside the receptacle;
an inlet gas flow communication with the receptacle for controlling the introduction of gaseous substances into the receptacle; and
a cooling device for rapidly decreasing the temperature inside the receptacle.

The receptacle may include a furnace. The receptacle may include a deposition chamber. The receptacle may take the form of a quartz vessel. The receptacle may take the form of a quartz tube.

The graphene growth substrate may include quartz wool. The graphene growth substrate may include coarse quartz wool having a fibre thickness ranging between, but not limited to, 9 and 30 μm.

The heating device may increase the temperature inside the receptacle to the desired temperature so as to allow annealing of the graphene growth substrate and subsequent graphene growth. The heating device may be configured to increase the temperature inside the receptacle at a rate of about 10 degrees celcius per minute up to about 1200 degrees celcius. The conditions for annealing the graphene growth substrate may be kept at a constant for a period of about ten minutes. The anealing time may range from between 5 and 60 minutes.

The gaseous substances may include any one or more of the group consisting of argon, hydrogen and graphene wool growth agent. The graphene wool growth agent may include methane.

The argon and hydrogen gas may be introduced into the receptacle at a flow rate of 500 sccm argon and 500 sccm hydrogen, respectively.

The argon and hydrogen gas may be introduced into the receptacle at a flow rate ranging between 1 and 500 sccm, respectively.

The graphene wool growth agent may be introduced into the receptacle at a flow rate of about 100 sccm for a period of about 30 minutes. The graphene wool growth agent may be introduced into the receptacle at a flow rate ranging between 20 and 200 sccm for a period ranging between 10 and 180 minutes under temperature ranging between 800 and 1300 degrees celcius, preferrably 1200 degrees celcius for 30 minutes.

According to a second aspect of the invention there is provided a method for manufacturing graphene wool which includes at least the steps of:
introducing a suitable substrate into a suitable receptacle;
increasing the temperature inside the furnace under a constant flow of argon and hydrogen gas annealing the substrate;
introducing a graphene wool growth agent into the furnace; and decreasing the temperature inside the furnace under a constant flow of argon and hydrogen gas.

The receptacle may include a furnace and/or a deposition chamber.

The substrate may include quartz wool. The substrate may include coarse quartz wool having a fibre thickness ranging between, but not limited to, 9 and 30 μm.

The step of annealing the substrate may occur in the presence of argon and hydrogen gas. The argon and hydrogen gas may be introduced into the furnace at a flow rate of 500 sccm argon and 500 sccm hydrogen, respectively.

The argon and hydrogen gas may be introduced into the furnace at flow rates ranging between 1 and 500 sccm, respectively. The required temperature for annealing the substrate may be reached by increasing the temperature in the furnace at a rate of about 10 degrees celcius per minute up to about 1200 degrees celcius. The conditions for annealing the substrate may be kept at a constant for a period of about ten minutes. The anealing time may range from between 5 and 60 minutes.

The graphene wool growth agent may include methane.

The graphene wool growth agent may be introduced into the furnace at a flow rate of about 100 sccm for a period of about 30 minutes. The graphene wool growth agent may be introduced into the furnace at a flow rate ranging between 20 and 200 sccm for a period ranging between 10 and 180 minutes under temperature ranging between 800 and 1300 degrees celcius, preferrably 1200 degrees celcius for 30 minutes.

The invention extends to graphene wool produced by the above system and/or method of manufacture.

According to a third aspect of the invention there is provided an air pollutant trap which includes:
a sorbent; and
a housing for housing the sorbent,
   wherein the sorbent includes graphene.

The sorbent may include graphene wool.

The graphene may be characterised in that the Raman G-band from in-plane vibration and 2D-band associated with two phonons are present at ˜1600 cm⁻¹ and 2720 cm⁻¹, respectively, possibly with defect induced D-peaks present at ˜1350 cm⁻¹.

The sorbent may have a weight value ranging between 10 and 120 mg.

The sorbent may fill between 10 and 70 mm of the inner volume of the housing, preferably 50 mm.

The sorbent may be packed in the housing at a density ranging between 0.0568 and 0.1989 mg/mm³, preferably 0.1910 mg/mm³.

The sorbent may include desorption properties.

The ratio between mass: bed length: density may measure 120 mg: 50 mm: 0.1910 mg/mm³.

The housing may be in the form of a tube-like element. The housing may be in the form of a thermal desorption tube (TD tube).

The housing may be cylindrical in shape.

The housing may have an inner diameter measuring about 4 mm.

The housing may have an inner diameter: length aspect: inner volume ratio measuring 4 mm: 89 mm: 1118.41 mm³ or 4 mm: 178 mm: 2236.81 mm³.

The trap may further include a pump for initiating one directional flow of air through the housing towards the pump.

The pump may be connected in fluid communication with one end portion of the housing.

### Description of the Invention

The invention is now described by way of example with reference to the accompanying drawings.

### IN THE DRAWINGS

FIG. 1(a) is an optical microscope image showing a 50×50 μm² area used for imaging;

FIG. 1(b) is an optical microscope image with an overlay cluster image (distribution maps);

FIG. 1(c) illustrates the average Raman spectra corresponding to each colour of the cluster image shown in FIG. 1b;

FIG. 2(a) is an optical microscope image showing a 50×50 μm² area used for imaging;

FIG. 2(b) is an optical microscope image with an overlay cluster image (distribution maps);

FIG. 3(a) illustrates the average Raman spectra corresponding to each colour of the cluster image shown in FIG. 2(b);

FIG. 3(b) is a Raman mapping of D peak intensity;

FIG. 3(c) is a Raman mapping of G peak intensity; and

FIG. 3(d) is a Raman mapping of D-to-G peak intensity ratio with an average value of 0.699;

FIG. 4 shows a schematic representation of the air pollutant trap, in accordance with the invention; and

FIG. 5 shows the use of a Sinclair-La-Mer 270 condensation aerosol generator at a flow rate of 2,5 L/min for octane, and 5 L/min for dodecane and hexadecane.

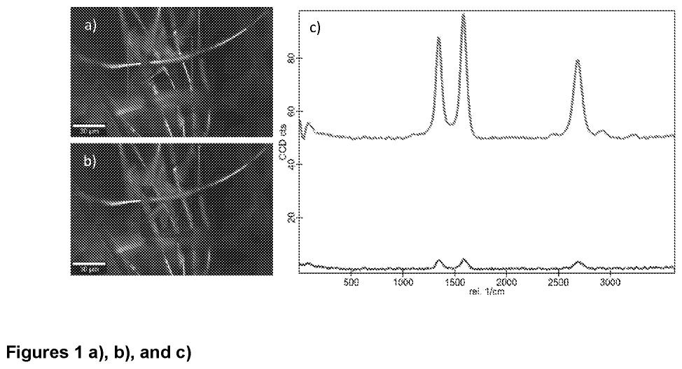

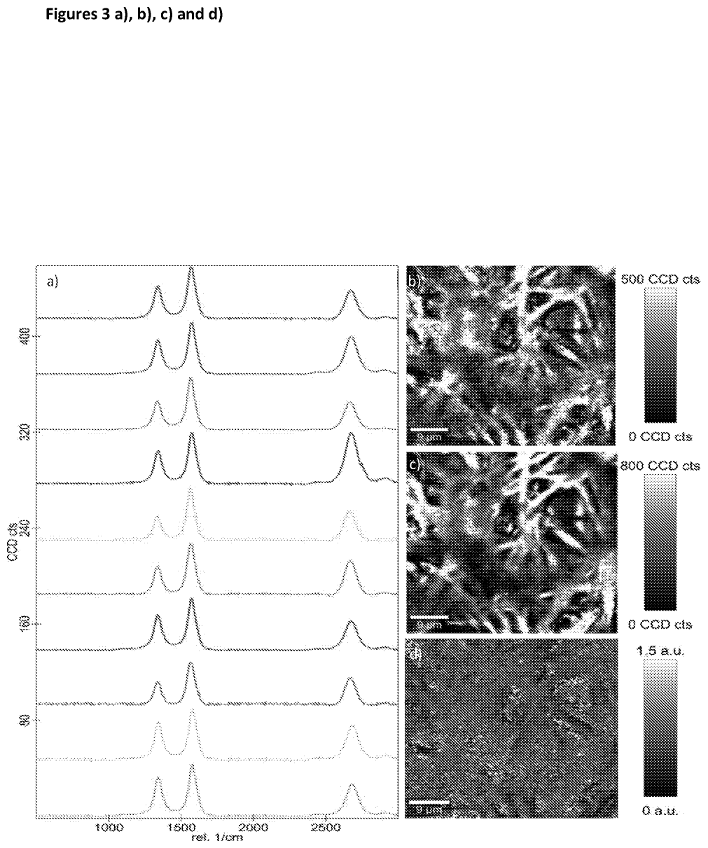

FIGS. 1 to 3 are in colour and conversion to grey scale or black and white results in loss of relevance. There is no other way to represent this information in black and white or grey scale. Accordingly, these figures are filed in this PCT application in colour.

Thus, with reference to FIGS. 1 to 3, there is provided a method for manufacturing graphene wool which includes at least the steps of introducing a suitable substrate into a furnace, annealing the substrate, introducing methane as a graphene wool growth agent into the furnace, and decreasing the temperature inside the furnace under a constant flow of argon and hydrogen gas.

The substrate will typically be in the form of coarse quartz wool having a fibre thickness ranging between 9 and 30 μm.

The step of annealing the substrate occurs in the presence of argon and hydrogen gas introduced into the furnace at a flow rate of 500 sccm argon and 500 sccm hydrogen, respectively. The temperature inside the furnace is increased at a rate of about 10 degrees celcius per minute up to about 1200 degrees celcius and these conditions are kept at a constant for a period of about ten minutes.

For graphene wool growth, the methane is preferrably introduced into the furnace at a flow rate of about 100 sccm for a period of about 30 minutes. The methane can also be introduced into the furnace at a flow rate ranging between 20 and 200 sccm for a period ranging between 10 and 180 minutes under a temperature ranging between 800 and 1300 degrees celcius, preferrably 1200 degrees celcius for 30 minutes.

### Experimental Data

### Method

Commercially available coarse quartz wool having a fibre thickness ranging between 9-30 μm (sourced from Arcos Organics, New Jersey, USA) was used as a substrate for the growth of graphene by atmospheric pressure chemical vapour deposition (CVD).

The quartz wool was placed in the middle of the horizontal quartz tube of the OTF 1200X-50-5L high temperature furnace (supplied by MTI Corporation, California,

USA).

A mixture of 500 sccm argon and 500 sccm hydrogen was introduced into the system after which the temperature was increased at a constant rate of 10° C./min up to 1200° C. The substrate was annealed under these conditions for 10 minutes after which 100 sccm methane was introduced for graphene growth for a period of 30 minutes.

After lapse of the growth period the system was cooled rapidly under presence of argon and hydrogen gas at a rate of approximately 14° C./min by shifting the furnace chamber off centre.

The following parameters were varied in order to achieve the highest quality graphene. It is however to be appreciated that graphene growth can be achieved using various combination of parameters within the following experimental ranges:
Methane gas flow (20-200 sccm)
Hydrogen gas flow (0-500 sccm)
Grow time (10-180 minutes)
Growth temperature (800-1300° C.)
Cooling rate (slow, rapid)

The Graphene wool was subsequently characterised by
1. Raman spectroscopy;
2. Scanning electron microscopy (SEM); and
3. X-ray photoelectron spectroscopy (XPS) as described hereunder

Raman characterization of synthesized graphene wool is shown in FIGS. 1 to 3.

Results

Raman signatures of graphene were clearly observed from the graphene grown on quartz and Raman G-band from in-plane vibration and 2D-band associated with two phonons were found at ˜1600 cm⁻¹ and 2720 cm⁻¹, respectively.

Defect induced D-peaks were also measured at ˜1350 cm⁻¹ and the intensities of D-peak varied.

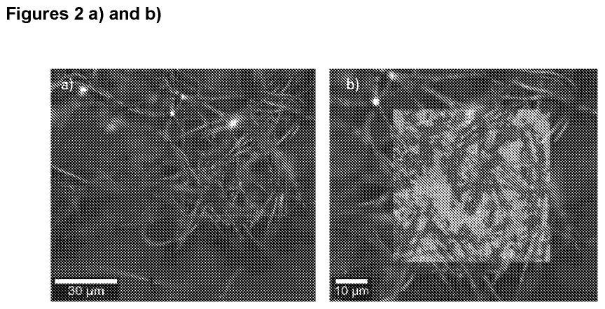

The mapping area is 50 μm×50 μm and Raman data was obtained at every 1 μm. The spot size of excitation laser was approximately 1 μm. As shown in the FIG. 2, the grown film was uniform over the area and the I_{D}/I_{G} values were mostly found at 0.7-0.9.

The applicant considers the invention advantageous in that a novel process and system is disclosed for manufacturing of novel graphene wool using quartz wool having a specific fibre thickness, preferably between 9 and 30 μm, as substrate for deposition of graphene introduced as gaseous methane into the system.

Since FIGS. 1 to 3 will be published in grey scale or black and white with a loss of relevance, the inventors refer the reader to a publication to which they contributed which provides a further example of the above and in which the use of colour makes the principles explained above comprehensible. The publication is “ Genna-Leigh Schoonraad, Moshawe Jack Madito, Ncholu Manyala and Patricia Forbes, Synthesis and optimisation of a novel graphene wool material by atmospheric pressure chemical vapour deposition, Journal of Materials Science, 2020, 55, 545-564” and can be viewed online in colour at https://doi.org/_10.1007/s10853-019-03948-0.

In this publication, which is an embodiment of the present invention, a novel graphene wool material was synthesised by non-catalytic chemical vapour deposition using a high-purity quartz wool substrate. The in situ synthesis method avoids post-growth transfer and isolation steps and allows the graphene to be directly synthesised into graphene wool. In the absence of a catalyst during graphene growth, the cracking of methane and nucleation is not as efficient, resulting in graphene defects which can be minimised by optimising the growth conditions. The roles of the methane and hydrogen flow rates in the synthesis of the graphene wool were investigated, as was the effect of growth temperature, growth time and cooling rates. The precursor flow rates and growth temperature were found to be the most vital parameters. The best quality graphene wool showed a minimum ratio of the disordered carbon relative to the graphitic carbon (ID/IG & 0.8) with a calculated crystallite grain size of 24 nm. The morphology of the optimised graphene wool was flake-like, and the X-ray photoelectron spectroscopy analysis revealed a surface composition of 94.05 at. % C 1 s and 5.95 at. % O 0 1 s. With this new material, the integrity of the synthesised graphene surface is preserved in use and it has the added advantage of structural support from the quartz substrate. Unlike many other forms of graphene, this fibrous graphene wool is flexible, malleable and compressible, allowing for a wealth of potential applications including in electronics, energy storage, catalysis, and gas sorption, storage, separation and sensing applications.

The above publication was submitted after the priority date of the present PCT application, however, the purpose of inclusion thereof herein is to assist the reader who does not have access to colour versions of FIGS. 1 to 3 to illustrate the invention.

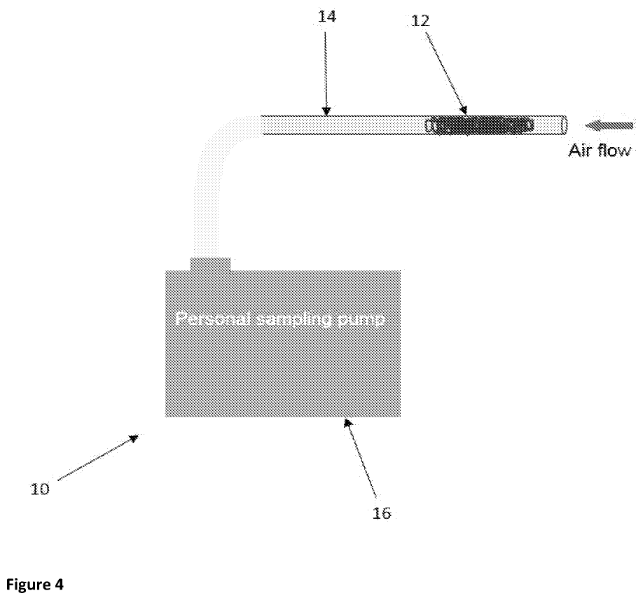

Referring now to FIG. 4, the air pollutant trap, in accordance with the invention, is generally indicated by reference numeral 10.

According to an embodiment of the invention there is provided an air pollutant trap 10 which includes a sorbent 12 comprising graphene, a housing 14 for housing the sorbent 12, and a pump 16 for initiating one directional flow of air through the housing 14 towards the pump 16.

The sorbent will typically include graphene and/or graphene wool.

The graphene used is further characterised in that the Raman G-band from in-plane vibration and 2D-band associated with two phonons are present at ˜1600 cm⁻¹ and 2720 cm⁻¹, respectively, with possible defect induced D-peaks present at ˜1350 cm⁻¹.

The sorbent 12 can have a weight value ranging between 10 and 120 mg.

The sorbent 12 can fill between 10 and 70 mm of the inner volume of the housing 14, preferably 50 mm spaced within the TD heating zone of the housing 14.

The sorbent 12 is further packed in the housing 14 at a density ranging between 0.0568 and 0.1989 mg/mm³, preferably 0.1910 mg/mm³.

The preferred ratio between mass: bed length: density of the sorbent 12 will preferably measure 120 mg: 50 mm: 0.1910 mg/mm³.

The sorbent 12 further includes desorption properties allowing the trap 10 to be re-used.

The housing 14 is further in the form of a tube-like element, preferably a cylindrically shaped thermal desorption tube (TD tube) having an inner diameter measuring about 4 mm.

The housing 14 can further have an inner diameter: length aspect: inner volume ratio measuring 4 mm: 89 mm: 1118.41 mm³ or 4 mm: 178 mm: 2236.81 mm³.

The pump may be connected in fluid communication with one end of the housing.

### Experimental

### 1. Substance Specific Gas Phase Collection Efficiency

Substance specific gas phase collection efficiency of the graphene wool adsorber was investigated using an experimental setup as depicted herein below.
The volatile and semi volatile gases included in the experiment included three alkanes:Octane (C8)
Dodecane (C12)
Hexadecane (C16)

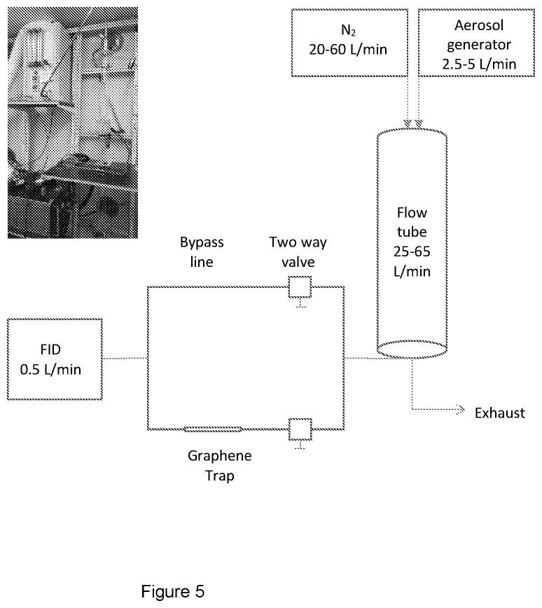

As shown in FIG. 5, the gases were individually vaporised by a Sinclair-La-Mer 270 condensation aerosol generator at a flow rate of 2,5 L/min for octane, and 5 L/min for dodecane and hexadecane, respectively, and further diluted with nitrogen to a total flow ranging from 25 to 65 L/min.

The generated aerosol was then passed through a 150 cm long flow tube to ensure evaporation of any remaining particles and the resultant gas was redirected through a bypass line and a graphene wool trap via copper tubing.

The alternate switching between the bypass line and the graphene trap was made possible by two way valves and the subsequent concentration of gas molecules was measured with a 109A type fame ionisation detector which was operated at a flow rate of 0.5 L/min.

The FID was calibrated daily with propane and the instrument zero was validated using pure nitrogen.

The concentration ratio measured between the GW trap and bypass line was used to obtain the time-dependent gas phase collection efficiency.

To ensure that the detected concentration was not biased from the adsorption of gases onto the copper tubing surface, the lines were saturated prior to the experiment by inserting an empty liner in place of the GW trap and verifying a constant FID signal. All experiments were performed in triplicate inside a temperature controlled chamber at 24.7±0.2° C.

### 2. Optimisation

The packing of the trap with graphene wool was optimised in terms of weight and packing density.

These parameters can be varied according to a specific application but for the purpose of the graphene wool for the intended use in a TD tube the following ranges were considered:
Weight of GW material (0.01-0.12 g)
Bed length (10-70 mm)

In order to determine the trapping capacity of the graphene wool traps as a function of the optimal packing of sorbent material in a glass TD tube, the gas phase collection efficiency for octane was determined at varying weights of sorbent material and then in turn compared to the well-known polydimethylsiloxane multichannel (PDMS) trap as well as against commercial activated charcoal adsorbent.

### 2.1 Result of Optimisation Study

Graphene wool gas phase collection efficiency increased from 42% to 94% when increasing the weight of the graphene wool from 0.01 g to 0,11 g in the glass liner.

The PDMS absorbent proved to be an ineffective medium for collection of volatile organic gasses, such as octane.

It must be noted that the mechanism and kinetics are different for the PDMS trap in that absorption takes place instead of adsorption as in the case of charcoal and graphene wool.

Charcoal showed excellent VOC adsorption properties, but the trade-off is more difficult desorption that requires time consuming solvent extraction steps. The commercial charcoal tube had a total weight of 900 mg with a bed length of 69 mm resulting in a much more tightly packed trap which allows gas molecules to penetrate deep into the sorbent surface.

Graphene wool on the other hand is only a thin surface layer of graphene which is why desorption is possible with the graphene wool trap and not the charcoal.

### 2.2 Gas Collection Efficiency as a Function of Packing Density

TABLE 1
Theoretical packing volume of a TD tube with
inner diameter of 4 mm as a function of tube length

| Bed length (mm) | Packing Volume (mm³) |
|---|---|
| 10 | 125.664 |
| 20 | 251.327 |
| 35 | 439.823 |
| 50 | 628.318 |
| 55 | 691.150 |
| 70 | 879.645 |

TABLE 2
Collection efficiency of graphene wool
as a function of bed length and packing density
in the TD tube shown in Table 1

| | Packed | Available | | |
|---|---|---|---|---|
| Mass of | bed | packing | Packing | Collection |
| graphene | length | volume | density | efficiency |
| wool (mg) | (mm) | (mm³) | (mg/mm³) | %(+−) |
| 50 | 70 | 879.645 | 0.0568 | 70 |
| 50 | 35 | 439.823 | 0.1137 | 76 |
| 50 | 20 | 251.327 | 0.1989 | 82 |
| 99 | 50 | 628.318 | 0.1576 | 90 |
| 110 | 55 | 691.150 | 0.1592 | 94 |

Gas phase collection efficiency is shown to be inversely proportional to packing density. More compact bed tends to increase adsorption due to shorter diffusion pathlengths and thus collection efficiency.

Alkane collection experiments where 120 mg of graphene was packed into a 50 mm bed yielding a density of 0.1910 mg/mm³ further showed gas phase collection efficiency over 90% within the first 10 minutes of adsorption.

Alkanes namely octane, dodecane and hexadecane were tested respectively.

The collection efficiency decreased slightly after 10 minutes but was stable for the next 3 hours at over 90% efficiency for each alkane. The dodecane was left overnight to determine breakthrough. The longer adsorption time would be applicable to an 8 hour shift of work.

When comparing collection efficiency between the three test alkanes octane (C8), dodecane (C10) and hexadecane (C16) it was detected that hexadecane took longer to reach maximum collection efficiency due to it being less volatile than octane and thus the adsorption kinetics are slower, which is also governed by diffusion coefficients.

Experimental design where the capacity of the graphene wool trap was tested showed that more than 90% collection efficiency was maintained for a period of 30 minutes for octane at a concentration of 20 g/m³.

Collection efficiency of more than 90% was also maintained for hexadecane, being less volatile than octane, for a period of 16 hours.

3. Desorption In order to determine the strength of adsorption and thus storage capabilities of graphene wool of trapped volatiles, nitrogen gas was passed through the trap whereby a FID signal would indicate desorption of analytes from the graphene wool.

Graphene wool containing trapped dodecane revealed that after a period of 8 hours a total of <2% of the adsorbed dodecane had been desorbed which can be considered insignificant and would not negatively impact the storage capabilities of the graphene wool as an adsorbent material.

### 4. Graphene Wool Trap for Airborne Polycyclic Aromatic Hydrocarbons

Diesel exhaust emission samples were collected by means of portable, battery operated personal sampling pump shown in FIG. 4, in fluid flow communication with the graphene wool trap.

As comparison a separate pump was used to sample onto a polydimethylsiloxane (PDMS) trap.

A low flow rate of ˜500 mL/min was employed during a 10 minute sampling interval. The PDMS trap comprised a 178 mm long glass tube, 6 mm o.d., 4 mm i.d. containing 22 parallel PDMS tubes (55 mm long, 0.3 mm inner diameter) that were prepared according to the method originally described in Ortner and Rohwer and the graphene wool trap was weighed and assembled in our laboratory according to optimised specifications.

After sampling, the two traps were end-capped with glass stoppers, wrapped in aluminium foil and placed in a freezer at −18° C. to prevent analyte loss prior to analysis.

The collection efficiency and extraction performance of the graphene wool trap having a weight of 120 mg and bed length of 50 mm was compared with a PDMS trap regarding the semi-quantification of individual polycyclic aromatic hydrocarbons (PAHs).

The group of polycyclic aromatic hydrocarbons consisted of acenaphthylene, acenaphthene, fluorene, phenanthrene, anthracene, fluoranthene and pyrene.

The total PAH concentration adsorbed on the graphene wool and PDMS trap were compared and each measured around 10 ng/5 L sample of diesel exhaust.

The test confirmed that the graphene wool trap is a good candidate for the sampling of n-alkanes and PAHs in air.

The Applicant considers the invention advantageous in that a novel graphene wool trap having excellent thermal stability and desorption properties is disclosed, wherein the graphene wool is manufactured employing chemical vapour deposition. The efficacy of the trap is further comparable to commonly known sorbents in the market such as PDMS and charcoal traps.

1. A system for manufacturing graphene wool which includes:
a receptacle;
a graphene growth substrate beatable inside the receptacle;
a heating device for increasing the temperature inside the receptacle;
an inlet gas flow communication with the receptacle for controlling the introduction of gaseous substances into the receptacle; and
a cooling device for rapidly decreasing the temperature inside the receptacle, wherein the graphene growth substrate includes quartz wool.

2. A system as claimed in claim 1 wherein the receptacle includes one or more of a furnace and a deposition chamber.

3. A system as claimed in claim 1, wherein the receptacle is a quartz vessel.

4. A system as claimed in claim 3, wherein the receptacle is a quartz tube.

5. (canceled)

6. A system as claimed in claim 1, wherein the graphene growth substrate includes coarse quartz wool having a fibre thickness ranging between 9 and 30 μm.

7. A system as claimed in claim 1, wherein the heating device increases the temperature inside the receptacle to the desired temperature so as to allow annealing of the graphene growth substrate and subsequent graphene growth at a rate of about 10 degrees Celsius per minute up to about 1200 degrees Celsius with the conditions for annealing the graphene growth substrate kept at a constant for a period of from 5 to 60 minutes.

8. A system as claimed in claim 7, wherein the annealing time is 10 minutes.

9. A system as claimed in claim 1, wherein the gaseous substances include any one or more of the group consisting of argon, hydrogen, and graphene wool growth agent.

10. (canceled)

11. A system as claimed in claim 9, wherein the argon and hydrogen gas are introduced into the receptacle at a flow rate of ranging between 1 and 500 standard cubic centimeters per minute (sccm), respectively.

12. A system as claimed in claim 9, wherein the argon and hydrogen gas are introduced into the receptacle at a flow rate of 500 standard cubic centimeters per minute (sccm) argon and 500 sccm hydrogen, respectively.

13. (canceled)

14. A system as claimed in claim 9, wherein the graphene wool growth agent is introduced into the receptacle at a flow rate ranging between 20 and 200 standard cubic centimeters per minute (sccm) for a period ranging between 10 and 180 minutes under temperature ranging between 800 and 1300 degrees Celsius.

15. A system as claimed in claim 14, wherein the temperature is 1200 degrees Celsius for 30 minutes.

16. A method for manufacturing graphene wool which includes at least the steps of:
introducing a suitable substrate into a suitable receptacle;
increasing the temperature inside the furnace under a constant flow of argon and hydrogen gas annealing the substrate;
introducing a graphene wool growth agent into the furnace; and
decreasing the temperature inside the furnace under a constant flow of argon and hydrogen gas.

17. (canceled)

18. An air pollutant trap which includes:
a sorbent; and
a housing for housing the sorbent, wherein the sorbent includes graphene wool.

19. An air pollutant trap as claimed in claim 18, wherein the graphene wool is characterised in that the Raman G-band from in-plane vibration and 2D-band associated with two phonons are present at about 1600 cm⁻¹ and 2720 cm⁻¹, respectively, possibly with defect induced D-peaks present at about 1350 cm⁻¹.

20. An air pollutant trap as claimed in claim 18, wherein the sorbent has a weight value ranging between 10 and 120 mg.

21. An air pollutant trap as claimed in claim 18, wherein the sorbent is packed in the housing at a density ranging between 0.0568 and 0.1989 mg/mm³.

22. An air pollutant trap as claimed in claim 21, wherein the sorbent is packed in the housing at a density of 0.1910 mg/mm³.

23. An air pollutant trap as claimed in claim 18, wherein the sorbent has desorption properties.

24. An air pollutant trap as claimed in claim 18, wherein the housing is in the form of a tube-like element.

25. (canceled)
